(19) United States
(12) Patent Application Publication
(10) Pub. No.: US 2004/0162668 A1
(43) Pub. Date: Aug. 19, 2004

(54) Method of detecting knock in an internal combustion engine

(76) Inventors: Stephen Rawlinson, Wiltshire (GB); Stuart Bailey, Wiltshire (GB); Richard Hughes, Wiltshire (GB)

Correspondence Address: David M. Carter, Esq., Carter, DeLuca, Farrell & Schmidt, LLP, 445 Broad Hollow Road, Suite 225, Melville, NY, 11747, US

(21) Appl. No.: 10/366,815

(22) Filed: Feb. 14, 2003

(51) Int. Cl. G01L 23/22

(52) U.S. Cl. 701/111

(57) ABSTRACT

A knock detection system using waveform shape descriptors (WSDs) is disclosed A time-varying signal is provided by an accelerometer from which a stream of WSDs are generated. The stream of WSDs is used to generate a matrix which is compared against archetype matrices to determine a knock level.

### FIELD OF THE INVENTION

The present invention relates to a method of detecting knock in an internal combustion engine.

### BACKGROUND ART

Spark-initiated gasoline internal combustion engines, such as those found in motor vehicles, can suffer from a condition commonly known as “knock” and which may also be referred to as “auto ignition”.

During knock, there is uncontrolled combustion of fuel with multiple flame fronts, only one of which is initiated by the spark plug. Knocking combustion takes place considerably faster than normal combustion. Consequently, heat is released more quickly and cylinder pressures are higher.

Low levels of knock generally have little detrimental effect on the engine. However, higher levels of knock can cause engine damage. For example, engine overheating can cause pitting of the pistons, which if it goes unchecked, increases friction between the piston and cylinder. This causes further auto-ignition, which in turn leads to the destruction of the engine. Also, high frequency pressure oscillations caused by knocking severely stress engine components including cylinder head, spark plugs, valves, pistons, connecting rods and crankshaft. If knocking goes on unnoticed, then serious damage to the engine can occur.

Current knock detection systems typically operate within the frequency domain using techniques such as Fast Fourier Transforms and Wavelet Analysis. However, these systems cannot reliably detect engine knock due to the presence of engine noise resulting from, for example, piston slap or valve guide wear, particularly at higher frequencies. Existing systems are not able to detect knock reliably at engine speeds over 4000 rpm and some are not able to detect knock at engines speed of even 1000 rpm if the engine is particularly noisy.

The present invention seeks to provide an improved method of detecting knock in an internal combustion engine.

### SUMMARY OF THE INVENTION

According to a first aspect of the present invention there is provided a method of detecting knock in an internal combustion engine, the method comprising: providing a measurement of engine vibration in the form of a time-varying signal, dividing the time-varying signal into a plurality of waveforms, generating a waveform shape descriptor for each of the waveforms, generating a characteristic using the waveform shape descriptors, providing an archetype characteristic representative of engine knock and comparing the characteristic with the archetype characteristic.

The method may comprise providing a plurality of archetype characteristics each representative of a different level of knock intensity and comparing the characteristic with each of the archetype characteristics so as to determine a level of knock intensity. The method may comprise providing a plurality of archetype characteristics each representative of a different type of knock and comparing the characteristic with each of the archetype characteristics so as to determine type of knock. The method may further comprise outputting the level of knock intensity. The method may further comprise determining a time of ignition using the level of knock intensity. The dividing the time-varying signal into the plurality of waveforms and generating the waveform shape descriptor for each of the waveforms may comprise Time Encoded Signal (TES) encoding the time-varying signal. The generating the characteristic using the waveform shape descriptors may comprise generating a data matrix. The generating the data matrix may comprise generating a Time Encoded Signal Processing and Recognition (TESPAR) ‘A’-matrix. The method may comprise comparing the TESPAR ‘A’ matrix with a pre-prepared TESPAR ‘A’-matrix. The comparing the TESPAR ‘A’-matrix with the pre-prepared TESPAR ‘A’-matrix may comprise determining angular correlation between the matrices. The method may further comprise extracting a feature from the time-varying signal, providing an archetype waveform feature and comparing the feature with archetype waveform feature. The method may further comprise providing a plurality of archetype characteristics each representative of a different level of knock intensity and comparing the characteristic with each of the archetype characteristics so as to determine a level of knock intensity. The method may further comprise extracting a feature from a stream of waveform shape descriptors, providing an archetype descriptor feature and comparing the feature with archetype descriptor feature. The providing the measurement of engine vibration may comprise measuring engine vibration using an accelerometer. The providing the measurement of engine vibration may comprise measuring engine vibration during a combustion cycle of one cylinder. The method may comprise providing a measurement of engine vibration during a combustion cycle of each of a plurality of engine cylinders and generating a characteristic for each cylinder using a respective measurement. The method may comprise comparing a characteristic for each cylinder with an archetype characteristic for the cylinder. The method may comprise filtering the time varying signal prior to dividing the time-varying signal into a plurality of waveforms. The method may comprise amplifying the time-varying signal prior to dividing the time-varying signal into a plurality of waveforms. The method may further comprise digitally sampling the time-varying signal and dividing a digital representation of the time-varying signal into a plurality of digitally represented waveforms. The method may comprise digitally processing the digital representation of the time-varying signal and dividing the digitally processed digital representation of the time-varying signal into a plurality of digitally represented waveforms. The method may further comprise generating the waveform shape descriptor for each of the digitally represented waveforms. The method may further comprise outputting a signal in dependence upon the comparing the characteristic with the archetype characteristic

According to a second aspect of the present invention there is also provided method of providing an archetype characteristic for use in a method of detecting knock in an internal combustion engine, the method comprising providing a measurement of engine vibration in the form of a time-varying signal, dividing the time-varying signal into a plurality of waveforms, generating a waveform shape descriptor for each of the waveforms, generating a characteristic using the waveform shape descriptors and using the characteristic to provide the archetype characteristic.

The method may further comprise providing another characteristic and combining the characteristic and the other characteristic so as to provide the archetype characteristic. The combining the characteristic and the other characteristic may comprises taking a mean of the characteristic and the other characteristic. The dividing the time-varying signal into the plurality of waveforms and generating the waveform shape descriptor for each of the waveforms may comprises Time Encoded Signal (TES) encoding the time-varying signal. The generating the characteristic using the waveform shape descriptors may comprises generating a data matrix. The generating the data matrix may comprise generating a Time Encoded Signal Processing and Recognition (TESPAR) ‘A’-matrix. The method may further comprise extracting a feature from the time-varying signal. The method may further comprise storing the archetype characteristic in memory.

According to a third aspect of the present invention there is provided a method of detecting knock in an internal combustion engine, the method comprising using waveform shape descriptors.

According to a fourth aspect of the present invention there is provided a computer program which, when run by data processing apparatus, causes the data processing apparatus to perform the method of detecting knock in an internal combustion engine, the method comprising: providing a measurement of engine vibration in the form of a time-varying signal, dividing the time-varying signal into a plurality of waveforms, generating a waveform shape descriptor for each of the waveforms, generating a characteristic using the waveform shape descriptors, providing an archetype characteristic representative of engine knock and comparing the characteristic with the archetype characteristic.

According to a fifth aspect of the present invention there is provided a computer program product comprising a computer-readable medium storing the computer program.

According to a sixth aspect of the present invention there is provided a signal carrying the computer program.

According to a seventh aspect of the present invention there is provided a memory storing the computer program.

According to an eighth aspect of the present invention there is provided a computer program which, when run by data processing apparatus, causes the data processing apparatus to perform the method of providing an archetype characteristic for use in a method of detecting knock in an internal combustion engine, the method comprising providing a measurement of engine vibration in the form of a time-varying signal, dividing the time-varying signal into a plurality of waveforms, generating a waveform shape descriptor for each of the waveforms, generating a characteristic using the waveform shape descriptors and using the characteristic to provide the archetype characteristic.

According to a ninth aspect of the present invention there is provided apparatus for detecting knock in an internal combustion engine comprising a sensor configured to measure vibration of an engine and provide a time-varying signal, a processor configured to divide the time-varying signal into a plurality of waveforms, generate a waveform shape descriptor for each of the waveforms, generate a characteristic using the waveform shape descriptors, provide an archetype characteristic representative of engine knock and compare the characteristic with the archetype characteristic.

The sensor and processor may be comprised in an integral unit.

According to a tenth aspect of the present invention there is provided apparatus for detecting knock in an internal combustion engine comprising an engine management system, the engine management system including an input for receiving a measurement of engine vibration in the form of a time-varying signal and a processor configured to divide the tine-varying signal into a plurality of waveforms, generate a waveform shape descriptor for each of the waveforms, generate a characteristic using the waveform shape descriptors, provide an archetype characteristic representative of engine knock and compare the characteristic with the archetype characteristic.

According to an eleventh aspect of the present invention there is provided apparatus for detecting knock in an internal combustion engine comprising an input for receiving a measurement of engine vibration in the form of a time-varying signal, a processor configured to divide the time-varying signal into a plurality of waveforms, generate a waveform shape descriptor for each of the waveforms, generate a characteristic using the waveform shape descriptors, provide an archetype characteristic representative of engine knock, compare the characteristic with the archetype characteristic and determine a knock intensity indicator and an output for providing the knock intensity indicator for an engine management system.

According to a twelfth aspect of the present invention there is provided apparatus for providing an archetype characteristic for use in detecting knock in an internal combustion engine comprising an engine, a sensor configured to measure engine vibration and provide a time-varying signal, a processor configured to divide the time-varying signal into a plurality of waveforms, generate a waveform shape descriptor for each of the waveforms, generate a characteristic using the waveform shape descriptors and using the characteristic to provide the archetype characteristic.

### BRIEF DESCRIPTION OF THE DRAWINGS

Embodiments of the present invention will now be described, by way of example, with reference to the accompanying drawings in which:

FIG. 1 shows an engine and an engine control system including a knock detection sub-system according to the present invention;

FIG. 2 is a schematic diagram of the knock detection sub system shown in FIG. 1;

FIG. 3 is a schematic diagram of functions of a coder and generator unit;

FIG. 4 is a schematic diagram of a processing unit;

FIG. 5 is a schematic diagram of a computer-on-a-chip;

FIG. 6 is a process flow diagram of a method of detecting knock according to the present invention;

FIG. 7 shows a signal obtained from a normally-operating engine;

FIG. 8 shows a signal obtained from a knocking engine;

FIG. 9 illustrates a process of time-encoding;

FIG. 10 illustrates a process of generating a TESPAR ‘A’-matrix;

FIG. 11 shows a TESPAR ‘A’-matrix for a normally-operating engine;

FIG. 12 shows a TESPAR ‘A’-matrix for a knocking engine;

FIG. 13 illustrates a process of comparing matrices;

FIG. 14 shows an archetype TESPAR ‘A’ matrix of a cylinder in which there is no engine knock;

FIG. 15 shows an archetype TESPAR ‘A’-matrix of a cylinder in which there is engine knock;

FIG. 16 illustrates a process of determining knock level;

FIG. 17 shows another engine and another engine control system including a knock detection sub system according to the present invention;

FIG. 18 is a schematic diagram of the knock detection sub-system shown in FIG. 17;

FIG. 19 is a schematic diagram of functions of a TESPAR unit;

FIG. 20 is a schematic diagram of a processing unit;

FIG. 21 is a schematic diagram of a computer on-a-chip;

FIG. 22 is a process flow diagram of a method of generating an archetype matrix;

FIG. 23 is a process of averaging matrices; and

FIG. 24 is a process for processing an archetype library.

### DETAILED DESCRIPTION OF THE INVENTION

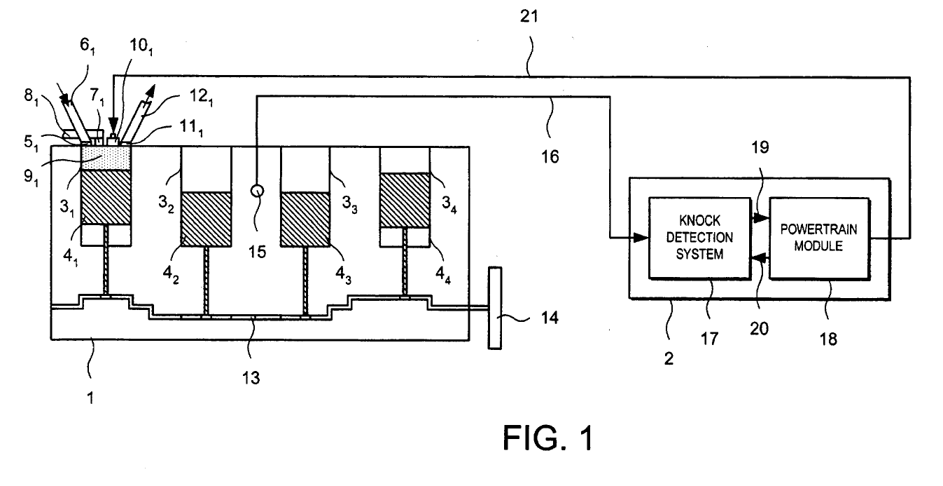

Referring to FIG. 1, an internal combustion engine 1 and associated engine control system 2 is shown. The engine 1 includes a plurality of cylinders 3₁, 3₂, 3₃, 3₄ and respective pistons 4₁, 4₂, 4₃, 4₄. In this example, the engine 1 includes four cylinders 3₁, 3₂, 3₃, 3₄. However, the engine 1 may have a fewer or greater number of cylinders and corresponding pistons.

Air is drawn into a first cylinder 3₁ through an inlet valve 5₁ from an inlet pipe 6₁. Fuel is injected into cylinder 3₁, by an injector 7₁ from a fuel line 8₁. The resulting mixture 9₁ of fuel and air is compressed and ignited by a spark plug 10₁. The resulting combustion gases are expelled through an outlet valve 11₁ into outlet pipe 12₁. The second, third and fourth cylinders 3₂, 3₃, 3₄ also have inlet valves, injectors, spark plugs and outlet valves, but these are not shown for the sake of clarity. Timed ignition and combustion of the mixture 9₁ of fuel and air in the cylinders 3₁, 3₂, 3₃, 3₄ drives against corresponding pistons 4₁, 4₂, 4₃, 4₄ which causes a crankshaft 13 to turn, thus turning a flywheel 14.

The engine 1 includes a knock sensor 15, in the form of an accelerometer, the output of which is fed, through a sensor line 16, into the engine control system 2.

The engine control system 2 includes a knock detection system 17 and a powertrain control module 18. The knock detection module 17 supplies a knock level signal 19 to the powertrain control module 18, while the powertrain control module 18 provides a timing signal 20 to the knock detection system 17. The powertrain control module 18 controls the spark plug 10₁ through line 21₁. Other spark plugs (not shown) are controlled by corresponding lines (not shown).

In this example, the knock detection system 17 is integrated into the engine control system 2. However, the knock detection system may be provided in the form of a separate module that feeds a knock level signal to a conventional engine control system (not shown). The knock detection system may be provided as a diagnostic tool. Alternatively, the knock sensor and knock detection system may be incorporated into a single “smart” sensor which feeds a knock level signal to a conventional engine control system (not shown).

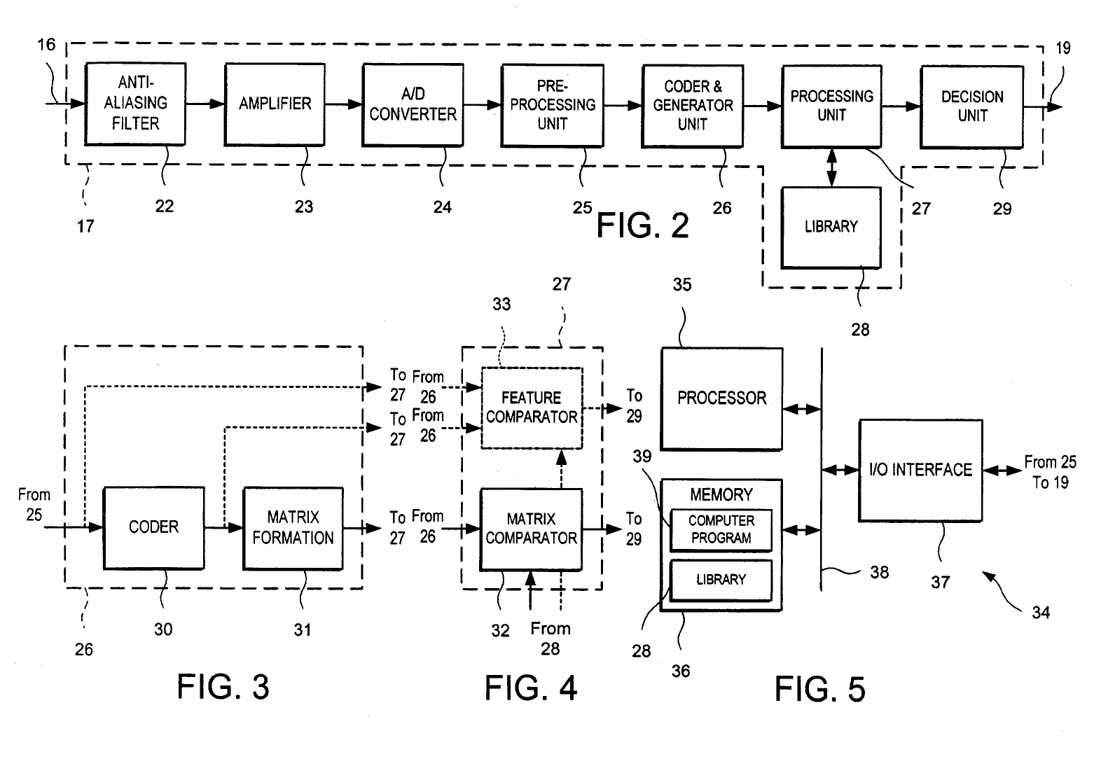

Referring to FIG. 2, functional units included in the knock detection system 17 are shown. The knock detection system 17 includes an anti-aliasing filter 22 for removing higher frequency signal components, an amplifier 23, an analog-to-digital (A/D) converter 24, a pre processing unit 25, a coder and generator unit 26, a processing unit 27, an archetype library 28 and a decision unit 29. Preferably, the anti-aliasing filter 22, amplifier 23 and A/D converter 24 are implemented by hardware components included in the engine control system 2.

Referring to FIG. 3, functional units included in the coder and generator unit 26 are shown. The coder and generator 26 includes a time-encoded signal (TES) encoder 30 and a time-encoded signal processing and recognition (TESPAR) matrix generator 31.

Time encoding and TESPAR are described in EP 0 166 607, EP 0 141 497, U.S. Pat. No. 5,519,805 and WO 97/45831, the entire contents of which are incorporated herein by reference.

Referring to FIG. 4, functional units of the processing unit 27 are shown. The processing unit includes a matrix comparator 32. The coder and generator may optionally comprise a feature comparator 33.

Referring to FIG. 5, the engine control unit 2 includes a microcomputer 34 comprising a processor 35, memory 36 and input/output interface 37 connected via bus 38. Memory 36 comprises volatile and non-volatile memory. The processor 35 runs a computer program 39 stored in memory 36 and provides the functions of the pre-processing unit 25, the coder and generator unit 26, the comparator unit 27 and the decision unit 29. Additionally or alternatively, a digital signal processor (not shown) may be used. One or more functional units 25, 26, 27, 29 may be implemented in hardware.

The archetype library 28 is stored in memory 36. The library 28 includes at least one archetype characteristic which is representative of engine knock and is used to determine whether knocking is occurring in engine 1, as will now be explained in more detail:

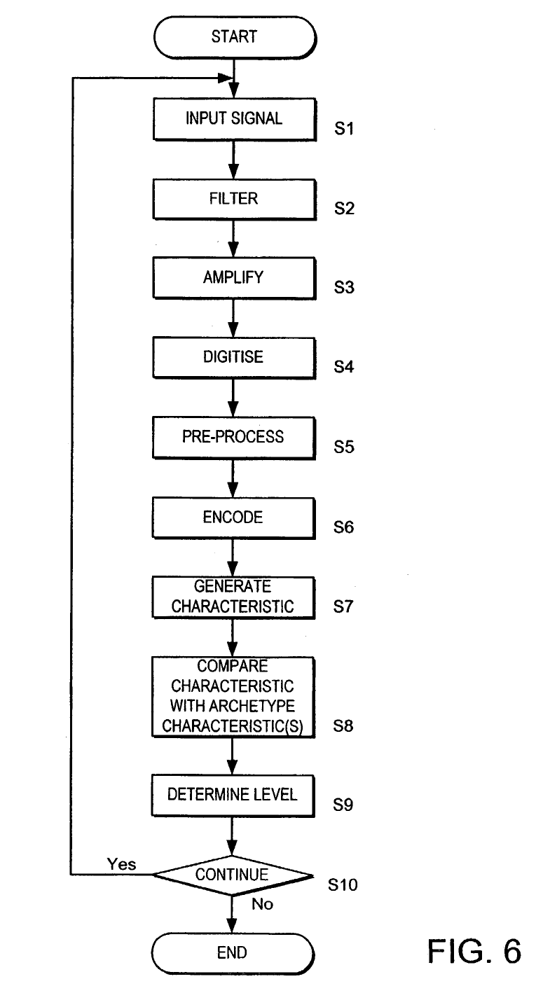

Referring to FIGS. 1 and 6, the knock sensor 15 provides a measurement of engine vibration in the form of an analog time-varying signal to the knock detection system 17 (step S1).

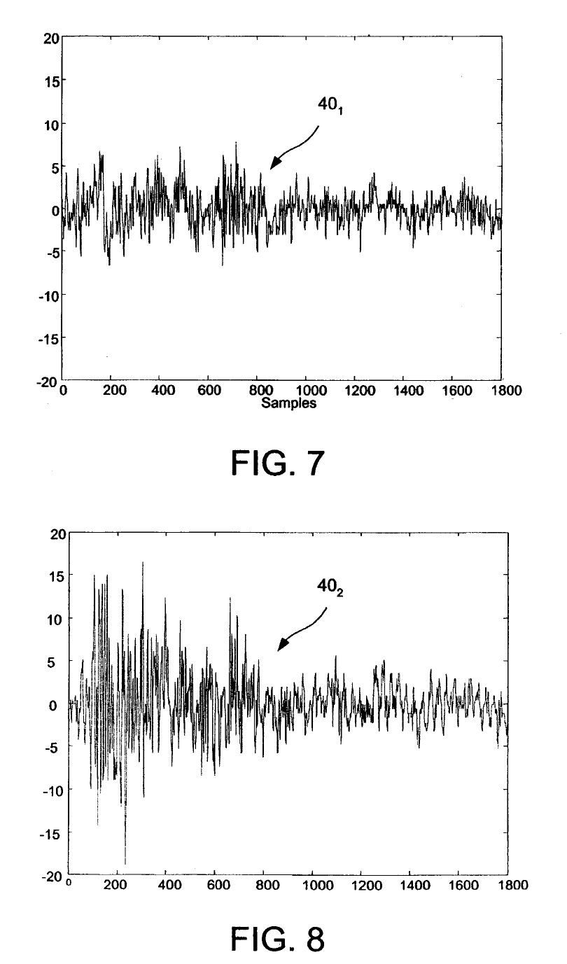

Referring to FIGS. 7 and 8, examples of time-varying signals 40₁, 40₂ from engine 1 are shown. The first time-varying signal 40₁ illustrates the engine 1 during normal operation during which substantially no knocking is occurring. The second time-varying signal 40₂ illustrates the engine 1 during which knocking is taking place.

Referring again to FIGS. 1 and 6, the time-varying signal is filtered using anti-aliasing filter 22 (step S2), amplified by amplifier 23 (step S3) and sampled using A/D converter 24 (step S4).

The signal is then pre-processed (step S5). Pre-processing may includes band pass filtering the digital signal so as to isolate frequencies of interest. This is because knock signals may be grouped into a number of frequency bands.

The signal is then coded, from which characteristics are identified or generated and thereafter compared with archetype characteristics using the processing unit 27 (steps S6, S7 & S8).

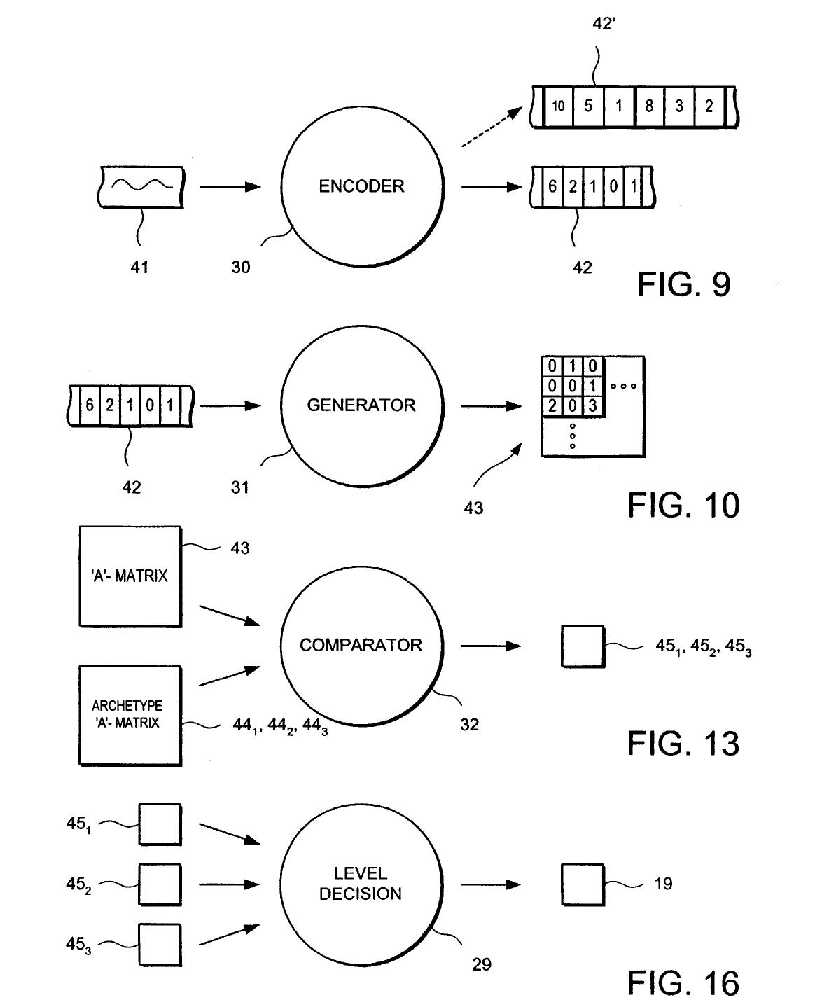

Referring to FIG. 9, the signal 41 is encoded to produce a stream of waveform shape descriptors (WSDs) 42, in this case in form of TES symbols (step S6). A stream of raw, uncoded waveform descriptors 42′ may also be produced.

The TES encoder 30 divides the signal 41 into segments between successive real zeros. Each waveform segment is coded, using a predefined code, into a digital word W, such as 0, 1, 2, 3, 4, . . . , w (where w is typically 29), according to two parameters, namely its quantised time duration D and shape S, i.e. W=W (S, D). The shape of the waveform is determined by studying the number of events, such as the number of maxima and minima, in the waveform between successive real zeros. Thus, for example, a code may specify that W=11 if D=15 and S=3. The stream of coded symbols is representative of the signal and may be used to reconstruct the signal. For example, a coded symbol stream may include a series of integers, such as 6, 0, 1, 1, 2, 11.

A stream of raw, uncoded waveform descriptors 42′ expressing, for example amplitude, duration and shape, may also be output from the coder 30 for later use in feature extraction.

Referring to FIG. 10, the stream of WSDs 42 is used to generate a characteristic 43, in this case in the form of a fixed-dimensional, fixed-size data matrix commonly known as a TESPAR ‘A’-matrix (step S7). A TESPAR ‘S’-matrix may also be used.

The TESPAR matrix generator 31 counts the number of occurrences that each descriptor is followed by the same and other descriptors in the stream, for example the number of occurrences that a “5” is followed by another “5”, i.e. n=5, m=5. The number of occurrences is recorded in row n, column m of an (wxw) matrix.

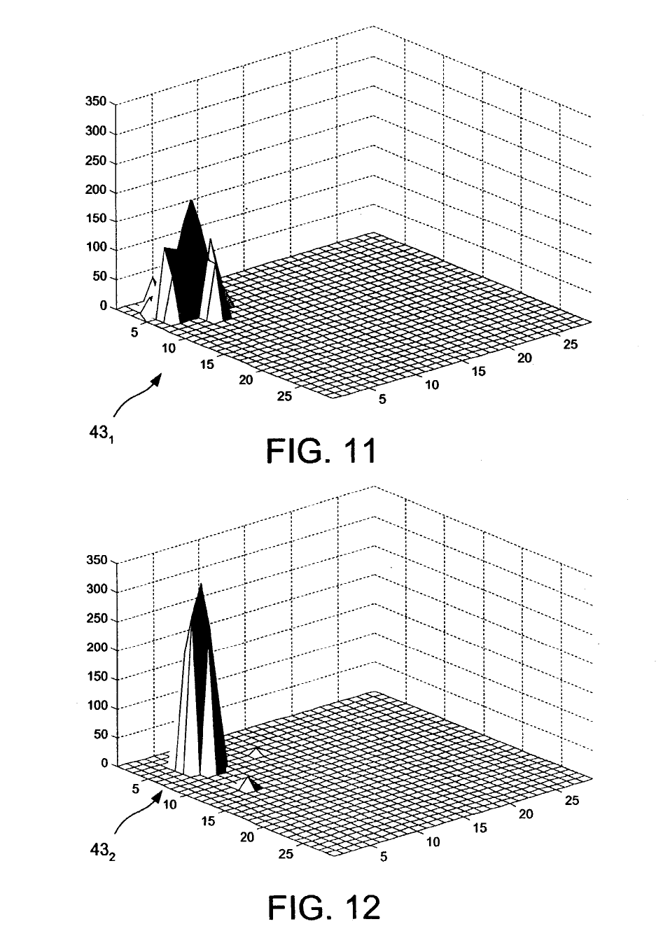

Referring to FIGS. 11 and 12, graphical representations of examples of ‘A’-matrices 43₁, 43₂ for engine 1 running at 3000 rpm are shown. The first ‘A’-matrix 43₁ is derived from the first time varying signal 43₁, when the engine 1 is operating normally. The second ‘A’-matrix 43₂ is derived from the second time varying signal 40₂ when knocking occurs.

A stream of ‘A’-matrices may be generated, for example by dividing the symbol stream according to the combustion cycle of each cylinder 3₁, 3₂, 3₃, 3₄.

Referring to FIG. 13, the characteristic 43, in this case an ‘A’-matrix, is compared with a plurality of archetype characteristics 44₁, 44₂, 44₃, in this case archetype ‘A’-matrices, which each represent a different level of engine knock (step S6). However, the characteristic may be compared with a single archetype characteristic 44₁.

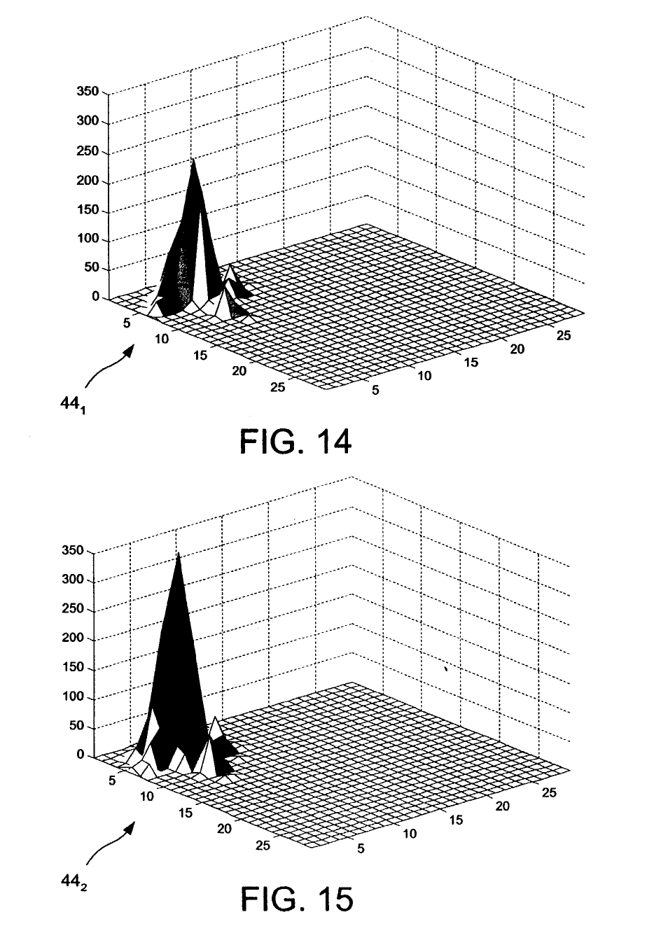

Referring to FIGS. 14 and 15, graphical representations of examples of archetype ‘A’-matrices 44₁, 44₂ for engine 1 running at 3000 rpm are shown. The first archetype ‘A’-matrix 44₁ is for a cylinder 3₁ in which there is substantially no knock. The second archetype ‘A’-matrix 44₂ is for a cylinder 3₁ in which there is knock. A method of generating archetype ‘A’ matrices 44₁, 44₂ will be described in more detail later.

Referring again to FIG. 13, the matrix comparator 32 compares the ‘A’-matrix 43, with each archetype ‘A’-matrix 44₁, 44₂, 44₃ and produces a corresponding correlation score 45₁, 45₂, 45₃ measuring the similarity between the matrices (step S8). Preferably, measuring similarity is achieved using angular correlation or magnitude correlation, although other techniques may be used.

Angular correlation cₐ compares the profile of the two matrices. This type of correlation is amplitude invariant. Magnitude correlation cₘ compares the shape and relative magnitudes of entries in the two matrices by taking the product of an angular correlation score and ratio of the sum of the squares of the two matrices. The angular correlation and magnitude correlation scores cₐ, cₘ are in a range 0≦Cₐ, cₘ≦1, where cₐ or cₘ=0 indicates no similarity, i.e. orthogonality, and Cₐ or Cₘ=1 indicates identity.

An angular correlation score cₐ, for matrices A and B is calculated as follows:

$${c}_{a} ( A , B ) = \frac{{( {\sum }^{} {a}_{ij} \cdot {b}_{ij} )}^{2}}{( {\sum }^{} {a}_{ij}^{2} ) ( {\sum }^{} {b}_{ij}^{2} )} \qquad ( 1 )$$

For two vectors A and B their dot-product is:

A.B=═A∥B═cosθ (2)

where θ is the angle between the two vectors. Equation (2) can be re-arranged to get:

$$cos θ = \frac{A \cdot B}{\vert A ‖ B \vert} \qquad ( 3 )$$

where

$$\begin{matrix}A \cdot B = {a}_{1} {b}_{1} + {a}_{2} {b}_{2} + Λ + {a}_{n} {b}_{n} = {\sum }^{} ab \\ \vert A \vert = \sqrt{{a}_{1}^{2} + {a}_{2}^{2} + Λ + {a}_{n}^{2}} = \sqrt{{\sum }^{} {a}^{2}} , and \\ \vert B \vert = \sqrt{{b}_{1}^{2} + {b}_{2}^{2} + Λ + {b}_{n}^{2}} = \sqrt{{\sum }^{} {b}^{2}} ,\end{matrix}$$

Thus, treating an n-by-m matrix as a 1-by-nm vector, equation 1 can be re-written as:

$${c}_{a} ( A , B ) = \frac{{( A \cdot B )}^{2}}{{\vert A \vert}^{2} {\vert B \vert}^{2}} = {cos}^{2} θ \qquad ( {1}^{′} )$$

The angular correlation score cₐ is, therefore, simply the square of the cosine of the angle between the two matrices A and B.

The magnitude correlation Cₘ is

Cₘ(A,B)=Cₐ(A,B)·r (4)

where

$$r = \{ \begin{matrix}\frac{{\vert A \vert}^{2}}{{\vert B \vert}^{2}} if {\vert B \vert}^{2} \geq {\vert A \vert}^{2} \\ \frac{{\vert B \vert}^{2}}{{\vert A \vert}^{2}} otherwise\end{matrix} ,$$

such that r≧1. This correlation reflects the correlation of both shape and magnitude of the two matrices.

A decision is then taken as to whether knocking is occurring and, if so, to what level (step S9).

Referring to FIG. 16, the decision unit 29 receives a plurality of scores 45₁, 45₂, 45₃ and identifies a highest score so as to determine which archetype ‘A’-matrix 44₁, 44₂, 44₃ is the most similar to the ‘A’-matrix 43₁ and, thus, best describes engine condition. Additionally, the decision unit 29 may also check whether the highest score exceeds a predetermined threshold so as to determine whether a meaningful match has been made. The decision unit 29 outputs a knock level signal 19 to the powertrain control module 18 (FIG. 1) for use in controlling ignition timing so as to correct for engine knock.

Other WSDs and other methods of characterising WSDs and comparing characteristics may be used. For example, an improved TESPAR coding method is described in GB 2 345 179, the entire content of which is incorporated herein by reference.

Additionally or alternatively, the processing unit 27 (FIG. 2) may extract features from the signal 41 or the stream of WSDs 42. The features are usually based upon statistical measures derived from amplitude duration and shape, or WSDs of epochs, such as average epoch duration, number of epochs, sum of epoch amplitudes, occurrences of specific combinations of WSDs. Signal features and/or WSD features may be compared against features stored in archetype library 28 (FIG. 2).

To enable knock detection to take place, archetype characteristics, in this case in the form of archetype ‘A’-matrix 44₁, 44₂, 44₃, are prepared and stored in archetype library 28. Usually, a motor vehicle or engine manufacturer prepares the archetype characteristics off-line using a test engine 1′ (FIG. 16), although the engine 1 may be used. This process is usually referred to as “training”.

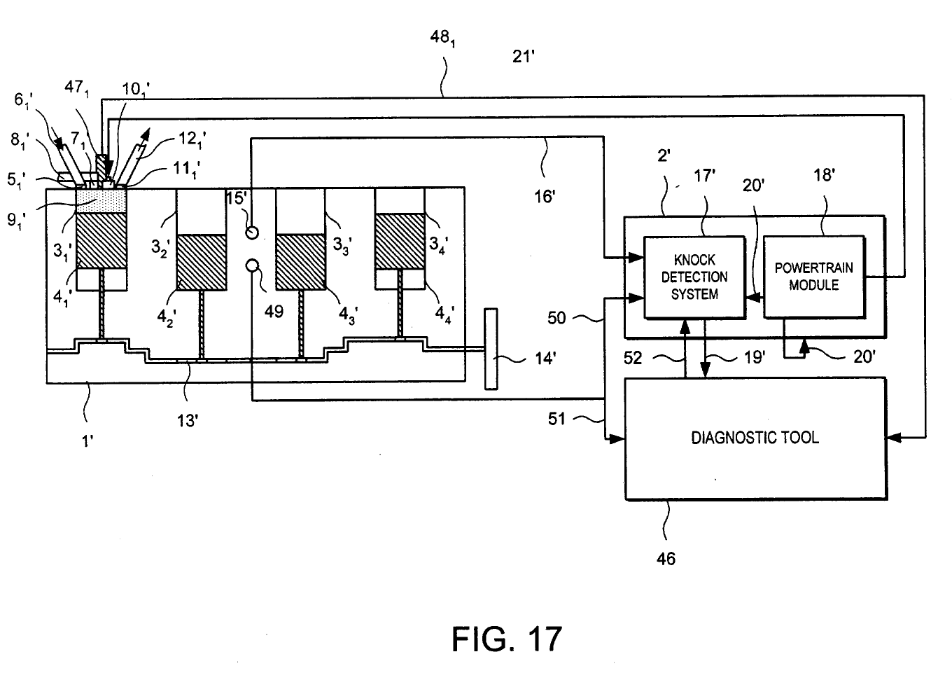

Referring to FIG. 17, an internal combustion engine 1′, associated engine control system 2′ and diagnostic system 46 for generating archetype characteristics is shown.

Preferably, the engine 1′ is made to be substantially the same or a similar design as the engine 1 described earlier. The engine 1′ has a plurality of cylinders 3_{1′, 3}₂′, 3₃′, 3₄′ and pistons 4₁′, 4₂′, 4₃′, 4₄′ as described earlier. A first cylinder 3₁′ is provided with an inlet valve 5, an inlet pipe 6₁′, injector 7₁′, fuel line 8₁′, spark plug 10₁′, outlet valve 11₁′ outlet pipe 12₁′. The second, third and fourth cylinders 3₂′, 3₃′, 3₄′ also have inlets valves, injectors, spark plugs and outlet valves, but these are not shown for the sake of clarity. Timed ignition of a mixture of fuel and air in the cylinders 3₁′, 3₂′, 3₃′, 3₄′ drives corresponding pistons 4₁′, 4₂′, 4₃′, 4₄′ causes a crankshaft 13′ to turn, so driving a flywheel 14′.

The first cylinder 3₁′ is also provided with a pressure sensor 47₁ for directly measuring pressure in the first cylinder 3₁′ for calibration. The second, third and fourth cylinders 3₂′, 3₃′, 3₄′ also have pressure sensors, but these are not shown for sake of clarity. The output of the pressure sensor 47₁ is fed into the diagnostic system 46 via line 48₁.

The engine 1′ includes a knock sensor 15′, in the form of an accelerometer, the output of which is fed, through a sensor line 16′, into a knock detection system 17′ as described earlier. The engine 1′ may also include an additional accelerometer 49 for providing more sensitive measurements of engine vibration, the output of which is fed through a sensor line 50 to the knock detection system 17′ and also into the diagnostic system 46 via line 51.

The knock level signal 19′ is provided to the diagnostic system 46. A control line 52 is provided from the diagnostic system 46 to the knock detection system 17′.

The knock detection system 17′ is substantially similar to the knock detection system 17 described earlier. However, in training mode, the processing unit 27 generates archetype characteristics rather than comparing matrices.

Referring to 18, the knock detection system 17′ includes an anti-aliasing filter 22′ for removing higher frequency signal components, an amplifier 23′, an analog-to-digital (A/D) converter 24′, a pre-processing unit 25′, a coder and generator unit 26′, a processing unit 27′, an archetype library 28′ and, optionally, a decision unit 29′.

Referring to FIG. 19, the coder and generator 26′ includes TES encoder 30′ and a TESPAR matrix generator 31′, as described earlier.

Referring to FIG. 20, functional units of the processing unit 27′ operating in training mode is shown. The processing unit includes a matrix averager 32′. Additionally or alternatively, the coder and generator may optionally comprise a feature averager 33′.

Referring to FIG. 21, the engine control unit 2′ includes a microcomputer 34′, for example in the form of a desk-top personal computer, comprising a processor 35′, memory 36′ and input/output interface 37′ connected via bus 38′. The processor 35′ runs a computer program 39′ stored in memory 36′ and provides the functions of the pre-processing unit 25′, the coder and generator unit 26′, the comparator unit 27′ and the decision unit 29′. Additionally or alternatively, a digital signal processor (not shown) may be used. One or more functional units 25, 26, 27, 29 may be implemented in hardware.

A method of generating archetype characteristics, particularly archetype ‘A’-matrices, will now be described:

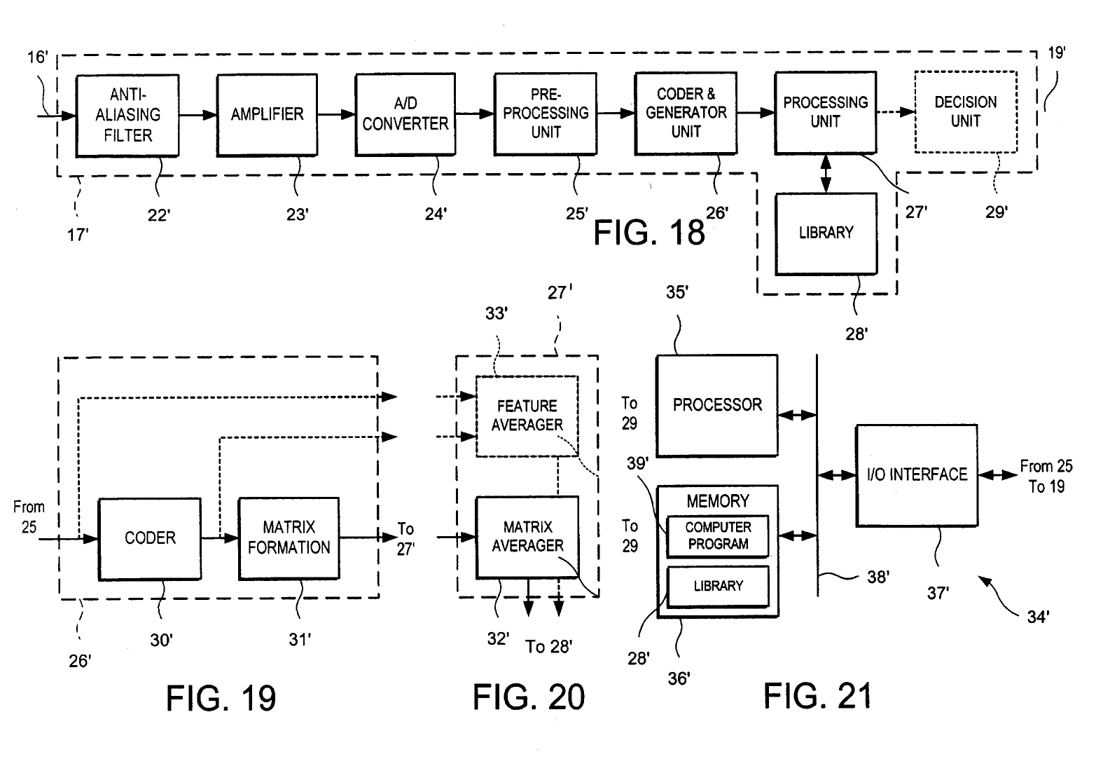

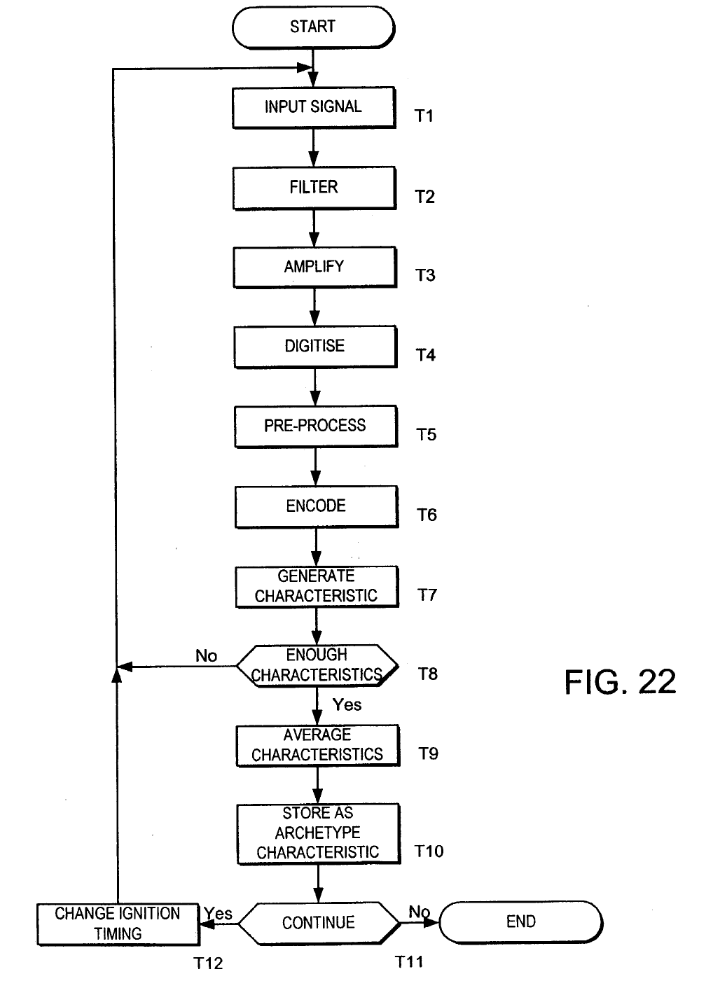

Referring to FIGS. 17, 18 and 22, the knock sensor 15′ provides a measurement of engine vibration in the form of an analog time-varying signal to the knock detection system 17′ (step T1). The time-varying signal is filtered using anti-aliasing filter 22′ (step T2), amplified by amplifier 23′ (step T3) and sampled using A/D converter 24′ (step T4). The signal is then pre-processed (step 15). Pre-processing may include band pass filtering the digital signal.

The signal is then coded, from which characteristics are identified or generated (steps T6 & T7). Averages of two or more characteristics may be taken (steps T8 & T9) and stored as archetype characteristics (step T10). Ignition timing can be varied so as to cause different levels of knock and thus acquire archetype characteristics corresponding to different levels of knock (steps T11 & T12).

The processes of encoding the signal to produce a stream of waveform shape descriptors (WSDs), in this case in form of TES symbols, and of generating a characteristic, in this case in the form of TESPAR ‘A’-matrix, are described earlier.

Referring to FIG. 24, a plurality of TESPAR ‘A’-matrices 43₁′, 43₂′, 43₃′ corresponding to a combustion cycle in different strokes of the same cylinder 31₁ are averaged so as to form the archetype matrix 44₁. Preferably, averaging comprises simply taking a mean of the matrices 43₁′, 43₂′, 43₃′ However, other methods may be used, such as taking a weighted mean. Furthermore, a selection process may be used to discard one or more matrices which are substantially different from other matrices.

The archetype library 28′ is built by adding archetype matrices for each cylinder 3₁′, 3₂′, 3₃′, 3₄′ at different knock levels.

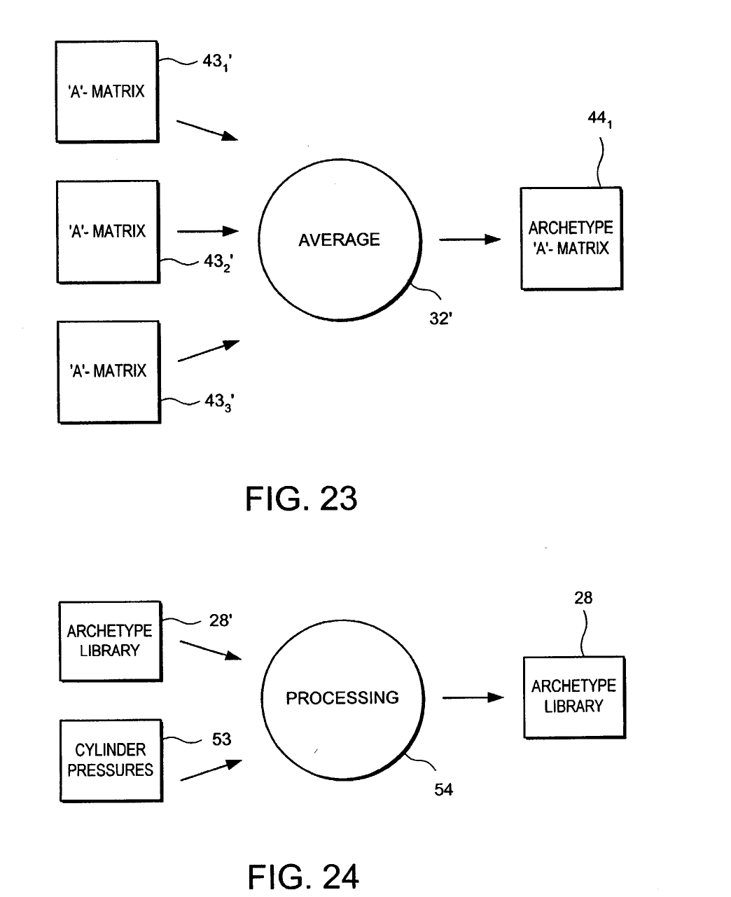

Referring to FIG. 23, the archetype library 28′ is analysed off-line together with cylinder pressure measurements 53 so as to identify knock level for each archetype matrix. Some matrices may be discarded. Other matrices from previous measurements may be included. A knock level is associated with each archetype matrix and a resulting archetype library 28 is prepared. The archetype library 28 is loaded into memory 36 (FIG. 5) for example when the motor vehicle is assembled. Alternatively, the archetype library 28 can be loaded to replace an existing archetype library.

The method of detecting engine knock described above is capable of successfully distinguishing between engine noise and a knocking signal. The knock signal, which is present within the accelerometer data, includes resonant and other noise components that are representative of the characteristics that are produced from the various engine load conditions. A change in engine load may cause a shift in the frequency range within which the knock signal is found. The shift in frequency represents a change in the fundamental frequency component of the informative knock signal as a result of changing engine conditions and loads. Such transformations can be accommodated using the method based on waveform shape descriptors.

Thus, the method has the advantage of providing real-time engine knock detection, which is capable of working in noisy engine environments over a range of engine loads, a range of engine speeds engine speeds, and at engine speeds up to and in excess of 4000 rpm and engine types.

The detection of the level of knock allows the engine to run at optimum performance and so results in improvements in power and fuel economy. Preferably, the engine is run at the level of inception of knock for optimum performance.

The method of training the knock detection system, i.e. preparing an archetype library, has the advantage being quicker than corresponding methods of training prior art knock detection systems.

It will be appreciated that many modifications may be made to the embodiments described above. Since numerous modifications and variations will occur to those who review this disclosure, the method of and apparatus for detecting knock in an internal combustion engine is not limited to the exact construction and operation illustrated and disclosed herein. Accordingly, this disclosure intends all suitable modifications and equivalents to fall within the scope of the claims.

1. A method of detecting knock in an internal combustion engine, the method comprising:
providing a measurement of engine vibration in the form of a time-varying signal;
dividing said time-varying signal into a plurality of waveforms;
generating a waveform shape descriptor for each of said waveforms;
generating a characteristic using said waveform shape descriptors;
providing an archetype characteristic representative of engine knock; and
comparing said characteristic with said archetype characteristic.

2. A method according to claim 1, comprising:
providing a plurality of archetype characteristics each representative of a different level of knock intensity; and
comparing said characteristic with each of said archetype characteristics so as to determine a level of knock intensity.

3. A method according to claim 2, further comprising:
outputting said level of knock intensity.

4. A method according to claim 3, further comprising:
determining a time of ignition using said level of knock intensity.

5. A method according to claim 1, wherein said dividing said time-varying signal into said plurality of waveforms and generating said waveform shape descriptor for each of said waveforms comprises:
Time encoded signal (TES) encoding said time varying signal.

6. A method according to claim 5, wherein said generating a characteristic using said waveform shape descriptors comprises:
generating a data matrix.

7. A method according to claim 6, wherein said generating said data matrix comprises:
generating a Time Encoded Signal Processing and Recognition (TESPAR) ‘A’ matrix.

8. A method according to claim 7, comprising:
comparing said TESPAR ‘A’-matrix with a pre-prepared TESPAR ‘A’-matrix.

9. A method according to claim 8, wherein said comparing said TESPAR ‘A’-matrix with said pre-prepared TESPAR ‘A’-matrix comprises:
determining angular correlation between said matrices.

10. A method according to claim 1, further comprising:
extracting a feature from said time-varying signal;
providing an archetype waveform feature; and
comparing said feature with said archetype waveform feature.

11. A method according to claim 1, further comprising:
extracting a feature from a stream of waveform shape descriptors;
providing an archetype descriptor feature; and
comparing said feature with said archetype descriptor feature.

12. A method according to claim 1, wherein said providing said measurement of engine vibration comprises:
measuring engine vibration using an accelerometer.

13. A method according to claim 1, wherein said providing said measurement of engine vibration comprises:
measuring engine vibration during a combustion cycle of one cylinder.

14. A method according to claim 1, comprising:
providing a measurement of engine vibration during a combustion cycle of each of a plurality of engine cylinders; and
generating a characteristic for each cylinder using a respective measurement.

15. A method according to claim 14, comprising:
comparing a characteristic for each cylinder with an archetype characteristic for said cylinder.

16. A method according to claim 1, comprising:
filtering said time-varying signal prior to dividing said time-varying signal into a plurality of waveforms.

17. A method according to claim 1, comprising:
amplifying said time-varying signal prior to dividing said time-varying signal into a plurality of waveforms.

18. A method according to claim 1, comprising:
digitally sampling said time varying signal and dividing a digital representation of said time varying signal into a plurality of digitally represented waveforms.

19. A method according to claim 18, comprising:
digitally processing said digital representation of said time-varying signal; and
dividing said digitally processed digital representation of said time-varying signal into a plurality of digitally represented waveforms.

20. A method according to claim 19, comprising:
generating said waveform shape descriptor for each of said digitally represented waveforms.

21. A method according to claim 1, further comprising:
outputting a signal dependent upon said comparing said characteristic with said archetype characteristc.

22. A method of providing an archetype characteristic for use in a method of detecting knock in an internal combustion engine, the method comprising:
providing a measurement of engine vibration in the form of a time-varying signal;
dividing said time varying signal into a plurality of waveforms;
generating a waveform shape descriptor for each of said waveforms;
generating a characteristic using said waveform shape descriptors; and
using said characteristic to provide said archetype characteristic.

23. A method according to claim 22, further comprising:
providing another characteristic; and
combining said characteristic and said other characteristic so as to provide said archetype characteristic.

24. A method according to claim 23, wherein said combining said characteristic and said other characteristic comprises:
taking a mean of said characteristic and said other characteristic.

25. A method according to claim 22, wherein said dividing said time-varying signal into said plurality of waveforms and generating said waveform shape descriptor for each of said waveforms comprises:
Time Encoded Signal (TES) encoding said time-varying signal.

26. A method according to claim 25, wherein said generating a characteristic using said waveform shape descriptors comprises:
generating a data matrix.

27. A method according to claim 26, wherein said generating said data matrix comprises:
generating a Time Encoded Signal Processing and Recognition (TESPAR) ‘A’-matrix.

28. A method according to claim 22, further comprising:
extracting a feature from said time-varying signal.

29. A method according to claim 22, further comprising:
storing said archetype characteristic in memory.

30. A method of detecting knock in an internal combustion engine, the method comprising:
using waveform shape descriptors.

31. A computer program which, when run by data processing apparatus, causes the data processing apparatus to perform the method of:
providing a measurement of engine vibration in the form of a time-varying signal;
dividing said time-varying signal into a plurality of waveforms;
generating a waveform shape descriptor for each of said waveforms;
generating a characteristic using said waveform shape descriptors;
providing an archetype characteristic representative of engine knock; and
comparing said characteristic with said archetype characteristic.

32. A computer program product comprising:
a computer readable medium for storing a computer program, wherein the computer program, when run by data processing apparatus, causes the data processing apparatus to perform the method of:
providing a measurement of engine vibration in the form of a time-varying signal;
dividing said time-varying signal into a plurality of waveforms;
generating a waveform shape descriptor for each of said waveforms;
generating a characteristic using said waveform shape descriptors;
providing an archetype characteristic representative of engine knock; and
comparing said characteristic with said archetype characteristic.

33. A signal carrying a computer program, which computer program, when run by data processing apparatus, causes the data processing apparatus to perform the method of:
providing a measurement of engine vibration in the form of a time-varying signal;
dividing said time varying signal into a plurality of waveforms;
generating a waveform shape descriptor for each of said waveforms;
generating a characteristic using said waveform shape descriptors;
providing an archetype characteristic representative of engine knock; and
comparing said characteristic with said archetype characteristic.

34. A memory storing a computer program, which computer program, when run by data processing apparatus, causes the data processing apparatus to perform the method of:
providing a measurement of engine vibration in the form of a time-varying signal;
dividing said time-varying signal into a plurality of waveforms;
generating a waveform shape descriptor for each of said waveforms;
generating a characteristic using said waveform shape descriptors;
providing an archetype characteristic representative of engine knock; and
comparing said characteristic with said archetype characteristic.

35. A computer program which, when run by data processing apparatus, causes the data processing apparatus to perform the method of:
providing a measurement of engine vibration in the form of a time-varying signal;
dividing said time-varying signal into a plurality of waveforms;
generating a waveform shape descriptor for each of said waveforms;
generating a characteristic using said waveform shape descriptors; and
using said characteristic to provide said archetype characteristic.

36. Apparatus for detecting knock in an internal combustion engine comprising:
a sensor configured to measure vibration of an engine and provide a time-varying signal; and
a processor configured to divide said time-varying signal into a plurality of waveforms, generate a waveform shape descriptor for each of said waveforms, generate a characteristic using said waveform shape descriptors, provide an archetype characteristic representative of engine knock and compare said characteristic with said archetype characteristic.

37. Apparatus according to claim 36, wherein said sensor and processor are provided in an integral unit.

38. Apparatus for detecting knock in an internal combustion engine comprising:
an engine management system, said engine management system including:
an input for receiving a measurement of engine vibration in the form of a time-varying signal; and
a processor configured to divide said time-varying signal into a plurality of waveforms, generate a waveform shape descriptor for each of said waveforms, generate a characteristic using said waveform shape descriptors, provide an archetype characteristic representative of engine knock and compare said characteristic with said archetype characteristic.

39. Apparatus for detecting knock in an internal combustion engine comprising:
an input for receiving a measurement of engine vibration in the form of a time-varying signal;
a processor configured to divide said time-varying signal into a plurality of waveforms, generate a waveform shape descriptor for each of said waveforms, generate a characteristic using said waveform shape descriptors, provide an archetype characteristic representative of engine knock, compare said characteristic with said archetype characteristic and determine a knock intensity indicator; and
an output for providing said knock intensity indicator for an engine management system.

40. Apparatus for providing an archetype characteristic for use in detecting knock in an internal combustion engine comprising:
an engine;
a sensor configured to measure engine vibration and provide a time-varying signal; and
a processor configured to divide said time-varying signal into a plurality of waveforms, generate a waveform shape descriptor for each of said waveforms, generate a characteristic using said waveform shape descriptors and using said characteristic to provide said archetype characteristic.
